(19) United States
(12) Patent Application Publication
(10) Pub. No.: US 2024/0025073 A1
(43) Pub. Date: Jan. 25, 2024

(54) OUTDOOR TOOL AND LUBRICATION SYSTEM THEREOF

(71) Applicant: Techtronic Cordless GP, Anderson, SC (US)

(72) Inventors: Nicholas Proby, Easley, SC (US); Eduardo Olvera, Anderson, SC (US); Nicholas Holowicki, Raleigh, NC (US)

(21) Appl. No.: 18/351,631

(22) Filed: Jul. 13, 2023

Related U.S. Application Data
(60) Provisional application No. 63/390,325, filed on Jul. 19, 2022.

(51) Int. Cl. B27B 17/12

(52) U.S. Cl. CPC B27B 17/12

(57) ABSTRACT

An outdoor tool and a lubrication system for an outdoor tool are provided. A tool includes a powerhead, a tool unit powered by the powerhead, and a lubrication system. The lubrication system includes a reservoir, a pump, and a check valve. The lubrication system is configured to transport a lubricant from the reservoir to an output that is configured to supply the lubricant to the tool unit. The check valve is a separate component from the pump and the reservoir and is spaced apart from the pump and the reservoir.

### CROSS-REFERENCE TO RELATED APPLICATIONS

The present application claims priority to U.S. Provisional Patent Application Ser. No. 63/390,325 filed on Jul. 19, 2022 the disclosure of which is incorporated by reference herein in its entirety.

### FIELD

The present disclosure relates generally to outdoor tools, and, more particularly, pole saws and chain saws.

### BACKGROUND

Outdoor tools, such as pole saws and handheld chainsaws, are used to perform outdoor tasks such as cutting tree branches and other vegetation. Pole saws and chainsaws cut through material using chains with cutting teeth. The chain is typically disposed in a track on a guide bar. The chain moves relative to the track, advancing the cutting teeth along the material being cut.

Frictional resistance between the chain and guide bar decreases saw efficiency. That is, the additional resistance between the chain and guide bar results in decreased energy capacity and fewer cuts which can be made between charging or refueling. To solve this problem, lubrication may be introduced between the chain and guide bar. However, too much lubrication can attract debris, interfere with electronic components of the tool, create a worse user experience, or even cause dripping.

Accordingly, improved outdoor tool oiling systems are desired in the art. In particular, lubrication systems which offer better use and operation would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a tool is provided. The tool includes a powerhead; a tool unit powered by the powerhead, the tool unit having a guide bar and a chain circumscribing a portion of the guide bar; and a lubrication system that provides lubricant to the chain. The lubrication system comprises a reservoir housing the lubricant, a pump, a check valve downstream of the pump and the reservoir, first tubing configured to transport a lubricant from the pump to the check valve and second tubing configured to transport the lubricant from the check valve to an output configured to supply the lubricant to the guide bar and the chain.

In accordance with another embodiment, a tool is provided. The tool includes a powerhead; a tool unit powered by the powerhead; and a lubrication system. The lubrication system comprises a reservoir, a pump, and a check valve. The lubrication system is configured to transport a lubricant from the reservoir to an output configured to supply the lubricant to the tool unit. The check valve is a separate component from the pump and the reservoir and is spaced apart from the pump and the reservoir.

In accordance with another embodiment, a lubrication system is provided. The lubrication system is configured to lubricate a tool head of an outdoor power tool. The lubrication system includes a reservoir, a pump, and a check valve. The lubrication system is configured to transport a lubricant from the reservoir to an output configured to supply the lubricant to the tool unit. The check valve is a separate component from the pump and the reservoir and is spaced apart from the pump and the reservoir. Both the reservoir and the check valve are oriented in a vertical direction relative to a tool head defined by an elongated direction of the tool head.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of a tool in accordance with embodiments of the present disclosure;

FIG. 2 is a schematic illustration of the operation of a tool including a lubrication system in accordance with embodiments of the present disclosure;

FIG. 3 is a partial side cutaway view of a tool in accordance with embodiments of the present disclosure;

FIG. 4 is a cross-sectional view of a check valve in accordance with embodiments of the present disclosure;

FIG. 5 is a partial side cutaway view of a tool in accordance with embodiments of the present disclosure;

FIG. 6 is a perspective view of a lubricant reservoir in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises.” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary. “or” refers to an inclusive- or and not to an exclusive- or. For example, a condition A or B is satisfied by any one of the following: A is true (or present) and B is false (or not present), A is false (or not present) and B is true (or present), and both A and B are true (or present)

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, tools described herein can utilize lubrication systems which more precisely dispense lubricant during operation of the tool by implementing one or an additional lubricant check valve downstream of a lubricant pump. In particular, the lubricant check valve is separate from the pump and a lubricant reservoir, the check valve can be positioned more advantageously in the tool housing to permit a more compact design. Moreover, the lubrication systems described herein can allow for sufficient lubrication of the tool while preventing excessive lubrication or leakage which may occur in traditional tools. Utilizing systems and methods described herein can therefore increase operational lifespan of the tool while decreasing leakage caused by excessive lubricant which may occur while the tool is inactive, stored, or otherwise not in use.

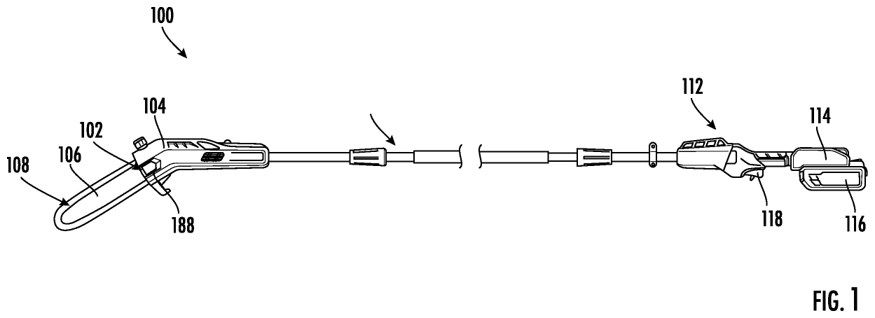

Referring now to the drawings, FIG. 1 illustrates a side view of a tool 100 in accordance with exemplary embodiments of the present disclosure. In particular, the tool 100 shown in FIG. 1 is a pole saw. The tool 100 has a lubrication system 102 disposed at least partially external to a housing 104 of the tool 100. In other aspects of the present invention, however, the lubrication system 102 may be disposed within the housing 104 and, for example, not visible from the exterior of the housing 104. The tool 100 can further include a guide bar 106 that receives a chain 140 (e.g., circumscribed around the guide bar 106), a pole assembly 110 such as a telescoping pole assembly, an upper housing 112 that may include a control assembly (not shown), a battery receiver 114, a battery 116 to power the tool 100, or any combination thereof.

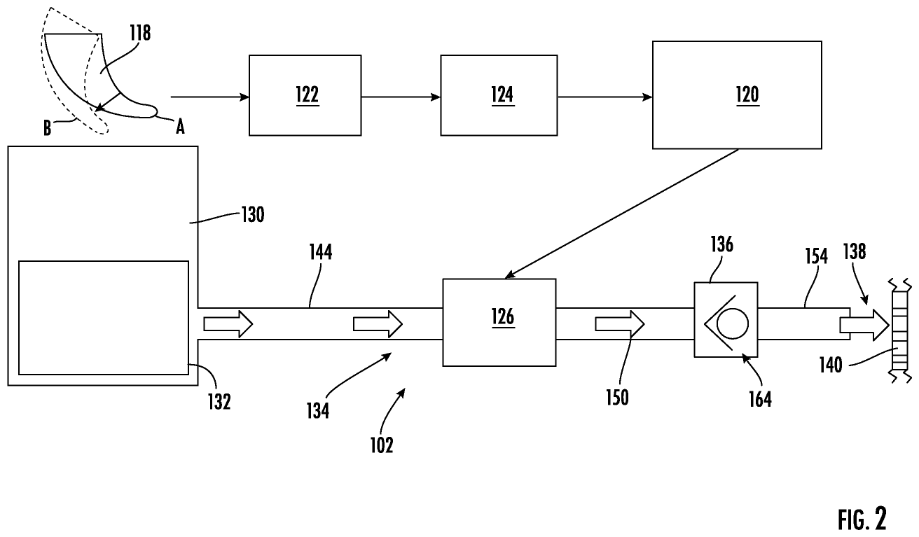

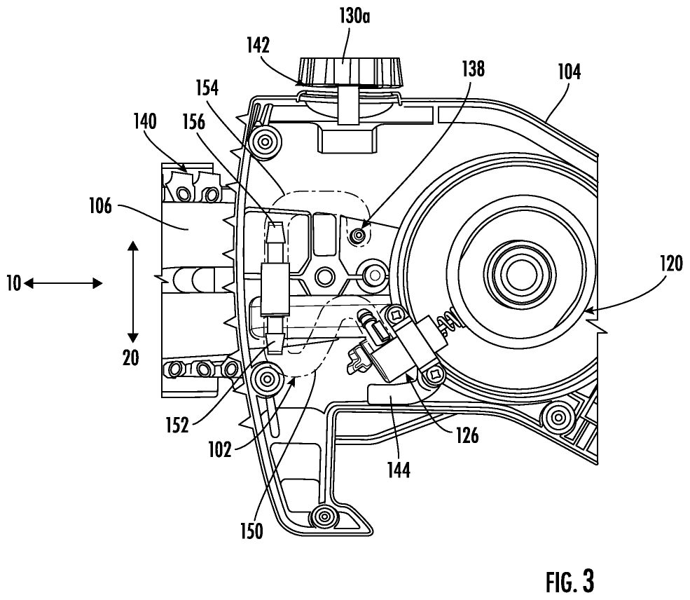

A user interface, e.g., a trigger 118, can be disposed at a location whereby an operator can control operation of the tool 100. The trigger 118 can control a powerhead 120 (FIGS. 3 and 5) of the tool 100 to drive the chain along the guide bar 106. By way of non-limiting example, the powerhead 120 can include a motor having an output shaft. The output shaft can be in communication with the chain, e.g., through a transmission having a drive gear, so as to move the chain along the guide bar 106. For instance, the drive gear may be rotatably coupled to the transmission, and the chain 140 may be in operable communication with the drive gear (e.g., the chain may circumscribe a portion of the drive gear) such that the drive gear can drive the chain about the guide bar. A sensor 122 (FIG. 2) can detect the relative position of the trigger 118. When the trigger 118 is activated, e.g., depressed, the speed of the powerhead 120 can increase. Conversely, when the trigger 118 is deactivated, e.g., not depressed, the powerhead 120 can stop. In certain instances, the powerhead 120 can be a variable speed motor and a relative activated position of the trigger 118 can inform the speed of the variable speed motor. That is, the operator can control the speed of the chain along the guide bar 106 based on how far the trigger 118 is depressed. A secondary user interface, e.g., a power button (not shown), can be used to control another aspect of the tool 100. The power button can include, for example, a toggle which can be moved between ON and OFF positions. The tool 100 may not function when the power button is in the OFF position.

FIG. 2 illustrates a schematic view of a lubricating operation in accordance with an exemplary embodiment of the present disclosure. During operation of the tool 100, a lubricating operation can provide lubricant via the lubrication system at an interface between the guide bar 106 and the chain so as to reduce friction and binding therebetween.

In general, the lubricating operation can initiate when the operator pulls the trigger 118 from the deactivated position A to the activated position B. This may be referred to as user input. It should be noted that in one or more embodiments, the power button must also be in the ON position to initiate the lubricating operation. As the user provides input, a sensor can detect activation of the trigger 118. The sensor 122 can be in communication with an electronic control unit (ECU) 124 which can receive information regarding the status of the trigger 118. For instance, the sensor 122 can communicate whether the trigger 118 is being depressed, a degree to which the trigger 118 is being depressed, or the like. The ECU 124 may be integrally part of the tool 100. By way of example, the ECU 124 may be part of a printed circuit board (PCB) of the tool 100. The ECU 124 may include, for example, a processor and a memory storage unit. The memory storage unit can store instructions which can be executed by the processor. For instance, the ECU 124 may control the powerhead 120 of the tool 100. When the trigger 118 is activated, the ECU 124 can instruct the powerhead 120 to drive the chain according to how far the trigger 118 is activated. Conversely, when the trigger 118 is deactivated, the ECU 124 can instruct the powerhead 120 to terminate driving the chain.

The ECU 124 may also be directly or indirectly in communication with the lubrication system 102 so as to control an aspect of the lubrication system 102. For instance, a pump 126 of the lubrication system 102 can be driven by the powerhead 120. Thus, when the trigger 118 is activated, i.e., depressed, the powerhead 120 can drive both the chain and the pump 126. Since the ECU 124 causes the powerhead 120 to drive the chain when the trigger 118 is activated, e.g., upon activation of the trigger 118, the powerhead 120 can cause lubrication to be pumped through a fluid conduit 134 and ultimately dispensed at a location adjacent to the chain so as to lubricate the chain.

Still referring to FIG. 2, the lubrication system 102 includes a lubricant reservoir 130 that houses a lubricant 132. The lubricant 132 can flow from the reservoir 130 to the pump 126 via a fluid conduit 134. Downstream of the pump 126, the lubrication system 102 includes a lubricant check valve 136. The lubricant 132 can be provided along the fluid conduit 134 to a location 138 adjacent to the chain 140 so as to lubricate the chain 140. The pump 126 can draw lubricant 132 from the reservoir 130 along the fluid conduit 134 and provide the lubricant at the location 138 adjacent to the chain 140.

When the trigger 118 is deactivated, i.e., the operator ceases to depress the trigger 118, the sensor 122 can detect the trigger 118 returning to the deactivated position A. The sensor 122 can communicate this information to the ECU 124 which can instruct the powerhead 120 to cease rotation. Because the pump 126 is driven by the powerhead 120, the pump 126 ceases pumping lubricant through the fluid conduit 134 when the trigger 118 is deactivated. Additionally, when the pump 126 stops pumping lubricant 132 through the fluid conduit 134, the fluid pressure upstream of the check valve 136 drops. The reduction in fluid pressure upstream of the check valve 136 may cause the check valve 136 to close, thereby preventing further flow of lubricant through the fluid conduit 134 beyond the check valve 136. As a result, no more lubricant 132 is provided to the location 138 adjacent the chain 140, thereby preventing drips or leakage of lubricant 132 when the tool 100 is not in use.

FIG. 3 illustrates a partial side cross-sectional view of a head portion of the tool 100 with the reservoir 130 removed, however, a lid 130a of the reservoir 130 is shown in place within an opening 142 of the housing 104. The fluid conduit 134 includes a channel 144 configured to fluidly couple the reservoir 130 to the pump 126. The channel 144 may be formed from a rigid material, e.g., metal, or any other suitable material, for instance a flexible material in other embodiments. The channel 144 may be fixed within the housing 104 such that the channel 144 is not configured to be movable within the housing 104. For instance, as shown in FIG. 3, the channel 144, as well as the pump 126, are affixed in place with one or more fasteners within the housing 104.

The pump 126 includes a pump inlet 146 and a pump outlet 148 configured to fluidly couple with the fluid conduit 134. In particular, the pump inlet 146 is coupled to the channel 144 upstream of the pump 126. The pump outlet 148 is coupled to a first tube 150 downstream of the pump 126. The first tube 150 is configured to fluidly couple the pump 126 to the check valve 136 along the fluid conduit 134. The first tube 150 is coupled to the check valve 136 at a check valve inlet fitting 152. Downstream of the check valve 136, a second tube 154 is fluidly coupled to the check valve 136 via a check valve outlet fitting 156. The second tube 154 may fluidly couple to a lubricant outlet at the location 138 adjacent to the chain 140 to provide the lubricant 132 to the chain 140.

As shown in FIG. 3, the first tube 150 and the second tube 154 may be formed from a flexible material configured to flex, bend, turn or otherwise flexibly surround other components within the housing 104 of the tool 100. For instance, the flexible material may be natural or synthetic rubber, nylon, polyethylene (PE) including but not limited to cross-linked polyethylene (PEX), poly-vinyl chloride (PVC) or any other flexible material suitable for transporting an oil-based lubricant. As a direct result of the flexibility of the tubes 150 and 154, the check valve 136 can be movably disposed within the housing 104 rather than being positioned in a fixed location. The flexibility of positioning of the check valve 136 can advantageously enable the housing 104 to have a more compact design.

Additionally, the relative orientation of the check valve 136 advantageously enables the compact design of the housing 104. Specifically, as shown in FIG. 3, the tool 100 extends in a generally horizontal direction 10 from the powerhead 120 to the guide bar 106, and the guide bar 106 itself further is an elongated bar that extends in the horizontal direction 10. The first tube 150 and the second tube 154 each extend generally in the horizontal direction 10 as well, albeit in a flexible and non-linear manner. However, the check valve 16 extends in a generally vertical direction 20, generally perpendicular to the horizontal direction of the housing 104 and the guide bar 106. By providing the check valve 136 in a vertical, i.e., up and down, direction, the check valve 136 takes up minimal space in the horizontal direction of the housing 104, thereby enabling the housing 104 to be advantageously compact. Moreover, by providing flexibility for the first tube 150 and the second tube 154 extending to and from the check valve 136, respectively, a horizontal distance from the pump 126 to the check valve 136 and from the check valve 136 to the location 138 adjacent the chain 140 can be advantageously shortened or reduced compared to a rigid fluid conduit.

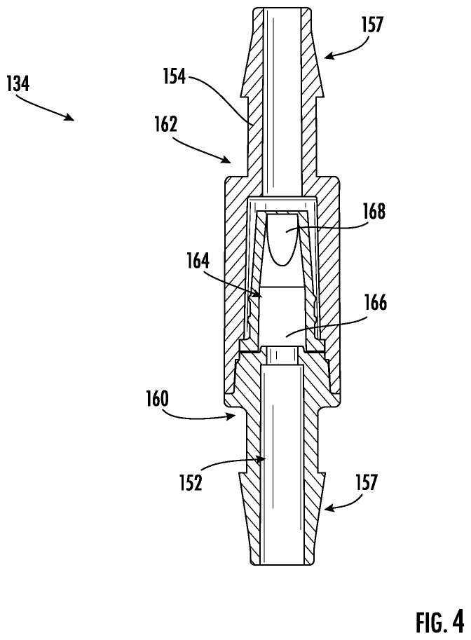

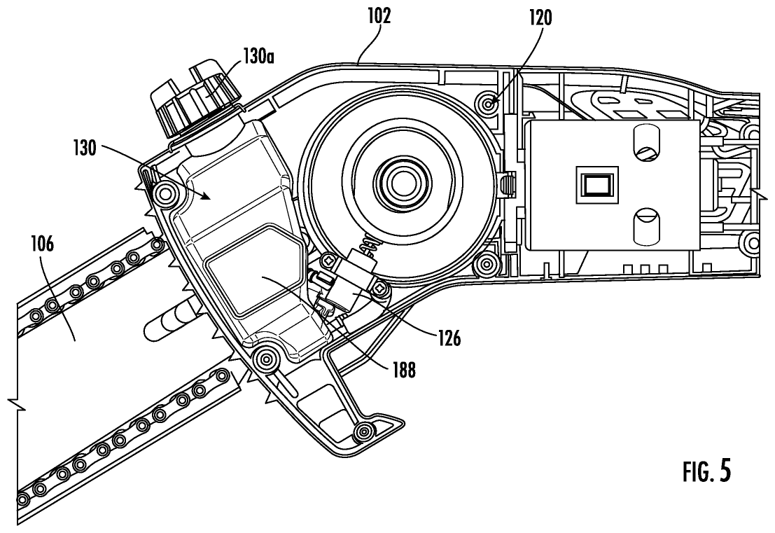

As best seen in FIG. 4, the check valve 136 includes an inlet fitting 152 and an outlet fitting 156 as described above. Both the inlet fitting 152 and the outlet fitting 156 may be configured to be inserted within the tubing, e.g., within a lumen of the first tube 150 or the second tube 154, respectively, and sealed by a friction fit. For example, the inlet fitting 152 and/or the outlet fitting 156 may include a barb-shaped insertion section 157 having a frustoconical outer surface. The inlet fitting 152 and the outlet fitting 156 are incorporated into a check valve housing 158. The check valve housing 158 can be formed from one or more pieces. For instance, the inlet fitting 152 may be formed as part of an upstream housing section 160 and the outlet fitting 156 may be formed as part of a downstream housing section 162.

A valve 164 is provided within the check valve housing 158 between the inlet fitting 152 and the outlet fitting 156. The valve 164 may be formed as a duckbill valve, e.g., may be shaped like the beak of a duck. The duckbill valve includes an open upstream end 166, e.g., having a generally circular shape or other open shape suitable for fluid to openly flow therethrough, and a closed downstream end 168. The closed downstream end 168 may include two or more flaps 170 that are flattened such that the flaps 170 come in contact with each other to close the fluid conduit 134 through the check valve 136. When there is no pressurized fluid, e.g., lubricant, flowing from the pump 126 to the check valve 136, the flaps 170 remain closed. When a pressurized fluid, e.g., lubricant, is pumped through the fluid conduit 134 from the pump 126 to the check valve 136, i.e., through the first tube 150, the downstream end 168 of the valve 164 is forced open by separating the flaps 170 to permit the pressurized fluid to pass. Then, when pressure is removed, the closed downstream end 168 returns to its flattened shape, preventing further fluid flow through the conduit 134 and further preventing backflow of fluid from the second tube 154 into the first tube 150.

As shown in FIGS. 3 and 4, the check valve 136, including the duckbill valve 164, extends in a vertical direction relative to the housing 104. The pump 126 is disposed at or below the inlet fitting 152 of the check valve 136 in the vertical direction, and lubricant 132 is required to flow upward in the vertical direction, i.e., against gravity, to pass through the check valve 136. Thus, the vertical orientation of the check valve 136 provides a further advantage for preventing leakage of lubricant 132 through the check valve 136 when the tool 100 is not in operation, as the lubricant 132 cannot flow vertically upward against gravity to pass through the check valve 136 without the flow or pressure generated by the pump 126.

The valve 164 may be a duckbill valve as described above or any other suitable valve configured to prevent backflow of fluid from the second tube 154 into the first tube 150. For instance, FIGS. 7A-C illustrate valve 264 that can be used in place of the duckbill valve 164 illustrated in FIGS. 3-4. In one embodiment, the valve 264 may be a stem valve. The stem valve may have an inlet fitting 262 and an outlet fitting 266 on opposite ends of the valve 264. The stem valve 264 may have a central portion 268 between the inlet fitting 262 and outlet fitting 266 through which fluid may flow. The central portion 268 may be wider than the inlet fitting 262 and outlet fitting 266 in a radial direction. The stem calve 264 may have a stem 270 and a valve head 272 disposed at one end of the stem 270 and disposed within the central portion 268. For instance, the stem 270 may extend toward or into the outlet fitting 268 and the valve head 272 may be disposed adjacent to the inlet fitting 262. The central portion 268 may have a floor 274 adjacent to the inlet fitting 262 and the valve head 272 may be configured to contact the floor 274 when the valve is in a closed configuration, as shown in FIG. 7A. As the valve stem 270 and valve head 272 move away from the floor 274, fluid may flow from the inlet fitting 262, through the central portion 268, and through the outlet fitting 266. In some aspects, the valve head 272 may have a diaphragm 276 at a surface thereof configured to contact with the floor

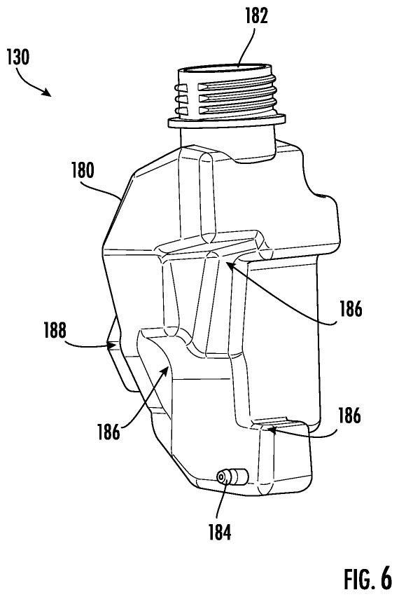

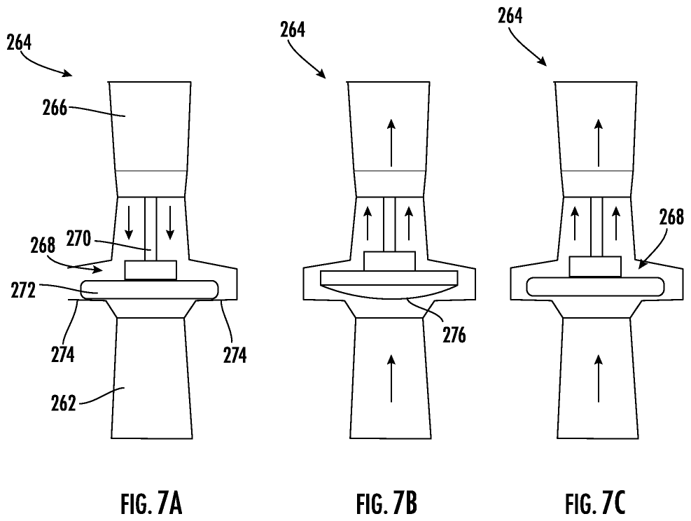

FIGS. 5 and 6 illustrate the reservoir 130 in place in the housing 104 and in an isolated rear perspective view, respectively. The reservoir 130 is formed from a body 180, e.g., a molded body that is blow-molded or formed by any other suitable method. The reservoir 130 includes an inlet 182, which may extend from the housing 104 such that an operator may pour lubricant 132 into the reservoir 130, and an outlet 184 configured to be in fluid communication with the channel 144.

The body 180 of the reservoir 130 is sized and shaped to extend in the vertical direction 20 from the inlet 182 to the outlet 184, where the inlet 182 is disposed higher than the outlet 184 in the vertical direction 20, i.e., the outlet 184 is lower than the inlet 182 in the vertical direction 20. More specifically, the body 180 of the reservoir 130 is sized and shaped in the vertical direction 20 to include one or more concave indentations 186 and convex protrusions 188 such that the reservoir 130 fits closely within the housing 104 while advantageously using available space to be able to hold a suitable volume of lubricant 132 within the body 180. For instance, one protrusion 188 is configured to extend outward through a portion of the housing 104 and may be exposed and visible from the exterior of the tool 100, as shown in FIG. 1. Moreover, the indentations 186 may be primarily disposed on an opposite side of the reservoir body 180 facing inward from the housing 104 such that the inner surface of the reservoir body 180 efficiently uses space within the housing 104 while fitting around other components of the tool 100 disposed within the housing 104. The molded, irregular size and shape of the reservoir body 180 and vertical orientation of the body 180 within the housing 104 further advantageously enable a more compact design of the housing 104 of the tool 100.

While FIG. 1 illustrates the tool 100 of the present invention as a pole saw, it is to be understood that the present invention contemplates the integration of the lubrication system 102 into other outdoor power tools that require lubrication such as chainsaws and the like.

Further aspects of the invention are provided by one or more of the following embodiments:

A tool comprises a powerhead; a tool unit powered by the powerhead, the tool unit comprising a guide bar and a chain circumscribing a portion of the guide bar; and a lubrication system that provides lubricant to the chain. The lubrication system comprises a reservoir housing the lubricant, a pump, a check valve downstream of the pump and the reservoir, first tubing configured to transport a lubricant from the pump to the check valve and second tubing configured to transport the lubricant from the check valve to an output configured to supply the lubricant to the guide bar and the chain.

The tool of any one or more of the embodiments, wherein the guide bar extends in a horizontal direction of the tool unit, further wherein the check valve extends in a vertical direction that is generally perpendicular to the horizontal direction.

The tool of any one or more of the embodiments, wherein the check valve comprises a valve disposed between an inlet fitting and an outlet fitting of the check valve.

The tool of any one or more of the embodiments, wherein the outlet fitting is positioned higher than the inlet fitting in a vertical direction.

The tool of any one or more of the embodiments, wherein the valve comprises a duckbill valve.

The tool of any one or more of the embodiments, wherein the valve comprises a stem valve.

The tool of any one or more of the embodiments, wherein at least one of the first tubing and the second tubing are flexible tubing.

The tool of any one or more of the embodiments, wherein the check valve is a separate component from the pump.

The tool of any one or more of the embodiments, wherein the valve is positioned higher than the pump in a vertical direction.

The tool of any one or more of the embodiments, wherein the check valve is positioned nearer to the guide bar than the pump and the reservoir.

The tool of any one or more of the embodiments, wherein the reservoir comprises a reservoir body having a surface at least partially exposed from a housing and an opposite surface disposed within the housing, the opposite surface comprising an indentation configured to receive the check valve and/or one or more components of the tool unit.

The tool of any one or more of the embodiments, wherein the reservoir is molded in an irregular shape to fit surrounding one or more components of the tool unit and/or powerhead.

The tool of any one or more of the embodiments, wherein the reservoir extends from an inlet opening to an outlet in a vertical direction, wherein the outlet is disposed in line with or lower than the inlet opening in the vertical direction, further wherein the outlet comprises an outlet fitting configured to be inserted into a channel to transport a lubricant from the reservoir to the pump.

The tool of any one or more of the embodiments, wherein the channel is formed from a rigid material.

The tool of any one or more of the embodiments, wherein the outlet fitting of the reservoir extends in a direction generally perpendicular to the vertical direction.

The tool of any one or more of the embodiments, wherein the tool is a pole saw or a handheld chainsaw.

A tool comprises a powerhead; a tool unit powered by the powerhead; and a lubrication system. The lubrication system comprises a reservoir, a pump, and a check valve, wherein the lubrication system is configured to transport a lubricant from the reservoir to an output configured to supply the lubricant to the tool unit. The check valve is a separate component from the pump and the reservoir and is spaced apart from the pump and the reservoir.

The tool of any one or more of the embodiments, wherein the check valve is positioned downstream of the reservoir and the pump.

A lubrication system is configured to lubricate a tool head of an outdoor power tool. The lubrication system comprises a reservoir, a pump, and a check valve. The lubrication system is configured to transport a lubricant from the reservoir to an output configured to supply the lubricant to the tool unit. The check valve is a separate component from the pump and the reservoir and is spaced apart from the pump and the reservoir. Both the reservoir and the check valve are oriented in a vertical direction relative to a tool head defined by an elongated direction of the tool head.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A tool comprising:
a powerhead; and
a tool unit powered by the powerhead, the tool unit comprising:
a guide bar and a chain circumscribing a portion of the guide bar;
a lubrication system that provides lubricant to the chain,
the lubrication system comprising a reservoir housing the lubricant, a pump, a check valve downstream of the pump and the reservoir, first tubing configured to transport a lubricant from the pump to the check valve and second tubing configured to transport the lubricant from the check valve to an output configured to supply the lubricant to the guide bar and the chain.

2. The tool of claim 1, wherein the guide bar extends in a horizontal direction of the tool unit, further wherein the check valve extends in a vertical direction that is generally perpendicular to the horizontal direction.

3. The tool of claim 1, wherein the check valve comprises a valve disposed between an inlet fitting and an outlet fitting of the check valve.

4. The tool of claim 3, wherein the outlet fitting is positioned higher than the inlet fitting in a vertical direction.

5. The tool of claim 3, wherein the valve comprises a duckbill valve.

6. The tool of claim 3, wherein the valve comprises a stem valve.

7. The tool of claim 1, wherein at least one of the first tubing and the second tubing are flexible tubing.

8. The tool of claim 1, wherein the check valve is a separate component from the pump.

9. The tool of claim 1, wherein the valve is positioned higher than the pump in a vertical direction.

10. The tool of claim 1, wherein the check valve is positioned nearer to the guide bar than the pump and the reservoir.

11. The tool of claim 1, wherein the reservoir comprises a reservoir body having a surface at least partially exposed from a housing and an opposite surface disposed within the housing, the opposite surface comprising an indentation configured to receive the check valve and/or one or more components of the tool unit.

12. The tool of claim 1, wherein the reservoir is molded in an irregular shape to fit surrounding one or more components of the tool unit and/or powerhead.

13. The tool of claim 1, wherein the reservoir extends from an inlet opening to an outlet in a vertical direction, wherein the outlet is disposed in line with or lower than the inlet opening in the vertical direction, further wherein the outlet comprises an outlet fitting configured to be inserted into a channel to transport a lubricant from the reservoir to the pump.

14. The tool of claim 12, wherein the channel is formed from a rigid material.

15. The tool of claim 12, wherein the outlet fitting of the reservoir extends in a direction generally perpendicular to the vertical direction.

16. The tool of claim 1, wherein the tool is a pole saw or a handheld chainsaw.

17. A tool comprising:
a powerhead;
a tool unit powered by the powerhead; and
a lubrication system comprising a reservoir, a pump, and a check valve, wherein the lubrication system is configured to transport a lubricant from the reservoir to an output configured to supply the lubricant to the tool unit, wherein the check valve is a separate component from the pump and the reservoir and is spaced apart from the pump and the reservoir.

18. The tool of claim 17, wherein the check valve is positioned downstream of the reservoir and the pump.

19. A lubrication system configured to lubricate a tool head of an outdoor power tool, the lubrication system comprising:
a reservoir, a pump, and a check valve,
wherein the lubrication system is configured to transport a lubricant from the reservoir to an output configured to supply the lubricant to the tool unit,
wherein the check valve is a separate component from the pump and the reservoir and is spaced apart from the pump and the reservoir, and
both the reservoir and the check valve are oriented in a vertical direction relative to a tool head defined by an elongated direction of the tool head.
